(19) United States
(12) Patent Application Publication
(10) Pub. No.: US 2005/0224173 A1
(43) Pub. Date: Oct. 13, 2005

(54) Sealing method

(76) Inventors: Shuichi Kitano, ST. PAUL, MN (US); Kotaro Shinozaki, Kanagawa (JP); Yuji Hiroshige, Tokyo (JP)

Correspondence Address: 3M INNOVATIVE PROPERTIES COMPANY, PO BOX 33427, ST. PAUL, MN, 55133-3427, US

(21) Appl. No.: 10/506,038

(22) PCT Filed: Feb. 11, 2003
(86) PCT No.: PCT/US03/07272

§ 371 Date: Aug. 26, 2004

(51) Int. Cl. B32B 31/26

(52) U.S. Cl. 156/307.7

(57) ABSTRACT

A sealing method comprising affixing an adhesive tape (e.g., a pressure-sensitive adhesive tape) to an adherend to be sealed, placing a sealing article that contains a hot-melt/fluidizable thermosetting sealing material on the adhesive tape, and heating the sealing article to a temperature sufficient to allow the article hot-melt/fluidize and thermoset. The adhesive tape has a substrate that suppresses penetration of air trapped in the affixing step between the adherend and adhesive tape into the sealing article.

### FIELD OF THE INVENTION

The present invention relates to sealing methods, in particular to a method of sealing a discontinuous portion, and more particularly to a method of sealing a joint.

### BACKGROUND OF THE INVENTION

A melt sealing tape that is a molded sealing material to be fluidized by heating and cured with the heat has been known in the prior technology aiming at sealing a discontinuous portion represented, for example, by a joint, etc. of an automobile (e.g., formed by steel sheets). Such molded sealing materials are disclosed in, for example, Japanese Unexamined Patent Publication (Kokai) No. 62-48787, U.S. Pat. No. 5,086,088, Japanese National Patent Publication (Kohyo) No. 9-505335, Japanese Unexamined Patent Publication (Kokai) No. 2000-17248, etc. Because the molded sealing material seals a discontinuous portion, it is first required to be melted and fluidized by heating. The sealing material then tends to match the shape of discontinuous portions and of an adherend, for example, depressions and recesses and protrusions. The shape of the discontinuous portions and of the adherend is reflected on the shape of the surface of the sealing material (namely, finish coating surface), thereby impairing the outer surface appearance. For example, for a groove called a roof ditch extending in the rear-to-front direction of the body both in the left side portion and in the right side portion of an automobile roof panel, the roof panel and the side panel are welded such as by spot welding in the groove bottom portion. As a result, a welding trace (a circular recess in spot welding) remains therein. When the trace is attempted to be sealed with a sealing material, air is likely to be trapped in a gap between the welding trace and the sealing material. The trapped air floats to the sealing material surface during melting. When bubbles thus formed are shrunk by cooling, the shrinkage produces cratering traces on the sealing material and moreover the surface of the automobile coating formed thereon. Furthermore, the trapped air reaches the sealing surface as bubbles when the sealing material is melted and cured. When the bubbles burst, traces such as craters remain on the sealing material surface to decrease the surface smoothness after painting and impair the outer appearance of the coating.

Japanese Unexamined Patent Publication (Kokai) No. 2000-192013 discloses a multilayer sealing article having a flexible film as a barrier layer in the sealing article or on the side opposite to the side facing the adherend of the sealing article. When an irregular bottom face having depressions and recesses that are formed by spot welding or the like, or a step formed by joining steel sheets is covered with the sealing article, such a barrier layer prevents the air trapped between the irregular bottom face and the sealing article from reaching the coating surface. As a result, deterioration of the outer appearance caused by bubbles on the coating surface can be prevented. As explained above, when a barrier layer is arranged in the intermediate layer of the sealing article, or on the surface layer of the side on which an automobile coating is to be applied, the trapped air can be prevented from reaching the automobile coating surface. However, because the air is taken in the inside of the sealing layer, the air tends to be present in separate, independent, complete spheres due to the influence of the surface tension. Such incorporated air spheres are expanded and shrunk by the rise and fall of the temperature in the coating and drying step of an automobile to form depressions and recesses on the surface of the sealing article, namely, on the surface of the automobile coating. Moreover, when the sealing article is required to have conformability to the shape of the groove bottom face to some extent, only a barrier layer having low rigidity can be used. It has therefore been difficult to obtain a satisfactory outer appearance, particularly a smoothness of a coating surface by the sealing method in which such a multilayer sealing article is used.

### SUMMARY OF THE INVENTION

A sealing method according to the present invention can be provided that is capable of decreasing defects such as depressions and recesses that may be formed on a coating surface such as, for example, an automobile coating (e.g., a painted surface), and imparting a coating appearance excellent in smoothness and decorativeness.

In one aspect of the present invention, a sealing method is provided that comprises affixing an adhesive tape (e.g., a pressure-sensitive tape) to an adherend to be sealed, placing a sealing article that contains a hot-melt/fluidizable thermosetting sealing material on the adhesive tape, and heating the sealing article to a temperature sufficient to allow the article to hot-melt/fluidize and thermoset. The adhesive tape has a substrate that suppresses penetration of air trapped in the affixing step between the adherend and adhesive tape into the sealing article.

Such a sealing method can improve the outer appearance of a coating surface (e.g., during painting of an automobile body), and prevent formation of the depressions and recesses on the coating surface.

### BRIEF DESCRIPTION OF THE DRAWINGS

FIGS. 1(a), (b) and (c) are each a schematic view that together show the steps of a sealing method according to the present invention.

FIGS. 2(a), (b) and (c) show conceptual views of the behavior of trapped air in sealing articles (FIG. 2(a) and FIG. 2(b)) in prior technologies, and a sealing article (FIG. 2(c)) according to the present invention.

FIG. 3 shows a perspective view of a test piece used in examples.

### DETAILED DESCRIPTION OF THE INVENTION

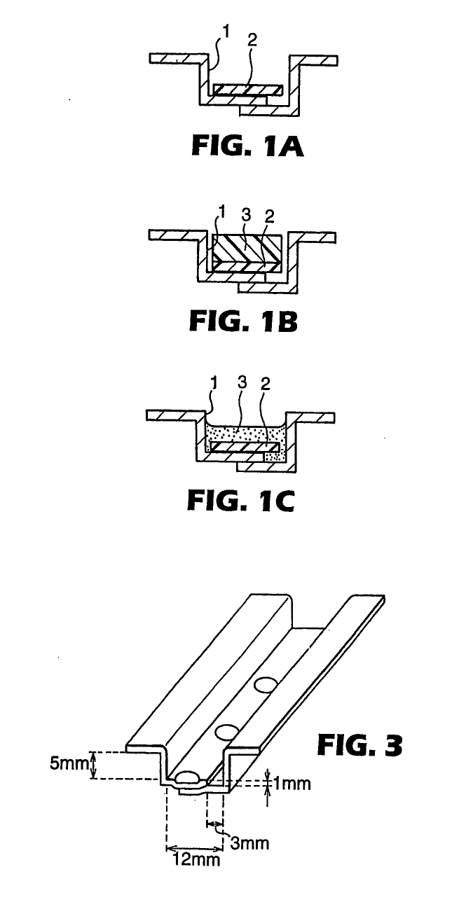

The sealing method of the present invention will be explained below by making reference to drawings. FIGS. 1(a), (b) and (c) show schematic views showing the steps of a sealing methods of the invention. First, in FIG. 1(a), a pressure-sensitive adhesive tape 2 having a rigid substrate is affixed to a roof ditch 1. Next, in FIG. 1(b) a sealing article 3 is placed on the pressure-sensitive adhesive tape 2, and in FIG. 1(c) the sealing article 3 is heated to temperature sufficient to allow the sealing article 3 to hot molten/fluidize and cure, so that the adherend is sealed.

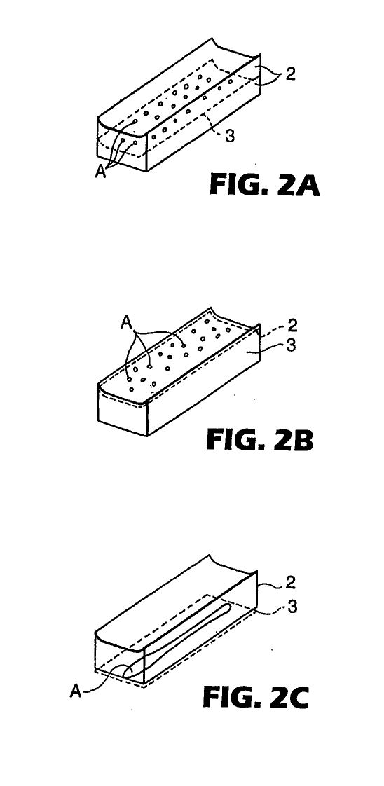

FIGS. 2(a) to 2(c) show conceptual views of the behavior of trapped air A in a sealing method according to conventional technologies (FIGS. 2(a) and 2(b)) and the sealing method (FIG. 2(c)) according to the present invention. Because a pressure-sensitive adhesive tape having a rigid substrate is affixed to an adherend prior to placing a sealing article on the adherend, the air trapped between the adherend and the pressure-sensitive adhesive tape cannot penetrate into the sealing article. Accordingly, a poor outer appearance caused by bubbles is not produced on the top surface of the sealing article (namely, surface to be coated). Moreover, because the method of the present invention differs from the sealing methods of the prior art in that the method of the invention forms no independent spherical air regions in the interior of the sealing article, expansion and shrinkage caused by the rise and fall of temperature hardly take place. As a result, depressions or recesses are hardly formed on the sealing article surface, namely, on the coating surface of an automobile.

Pressure-Sensitive Adhesive Tape

In the sealing method of the present invention, an adherend is covered with a pressure-sensitive adhesive tape having a substrate that suppresses the penetration into a sealing article of air trapped between the adherend and the pressure-sensitive adhesive tape during heating and curing the sealing article. The substrate must have a sufficient rigidity, and the substrate itself is required not to expand or shrink when the temperature is varied in the coating step. Because the substrate is required to have rigidity and heat resistance, the substrate is particularly preferred to have a tensile elastic modulus of at least 100 MPa at 120° C. at which temperature an electrodeposition coated steel sheet is precured. At least one of, or a combination of, a resin film, an unwoven fabric, a woven fabric, a metal, or the like can be used as the substrate. A resin film of any of the polymers including the following ones is appropriately used: polyesters such as poly(ethylene terephthalate) (PET), poly(butylene terephthalate) (PBT) and poly(ethylene naphthalate)(PEN); a polyamide (PA); a polyimide (PEI); a polyether ether ketone (PEEK); a polyether sulfone (PES); a polysulfone (PSF); and a polycarbonate (PC). The resin film is used for the following reasons. The resin film can sufficiently suppress the penetration of trapped air. When the resin film has a thickness of from 5 to 500 μm that is a practically used, the film shows a tensile elastic modulus of at least 100 MPa at 120° C., and thus shows sufficient rigidity and heat resistance. Here, the tensile elastic modulus is obtained by the following procedure: a strip-like test piece 25 mm wide and about 150 mm long is prepared by cutting a sample (barrier film); the test piece is held between two chucks 100 mm apart from each other of Autograph AG 500 D (trade name, manufactured by Shimazu Corporation), and pulled at a rate of 50 mm/min to give a stress-strain curve; and the elastic modulus is calculated between 5N and 10N from the curve. Moreover, in order to improve the rigidity of the substrate, the substrate may be reinforced with a fiber such as a glass or carbon fiber. In addition, although a polyolefin film such as a polyethylene film has a low tensile elastic modulus that decreases its usefulness to some extent, the use of the film in the invention achieves a certain effect.

A pressure-sensitive adhesive layer is placed on the substrate. The pressure-sensitive adhesive is used for temporarily holding the substrate to prevent it from shifting from a given position so that air to be trapped is prevented from escaping. The pressure-sensitive adhesive is satisfactory as long as it manifests pressure-sensitive adhesiveness until the sealant layer is melted and starts to cure. Accordingly, the type of pressure-sensitive adhesive is not particularly restricted, and any of commonly used rubber, acrylic and silicone pressure-sensitive adhesives may be used.

As explained above, the thickness of the substrate is usually from 5 to 500 μm. When the thickness of the substrate is less than 5 μm, there is the possibility that the trapped air cannot be shielded, and that the influence of the shrinkage and expansion of the air cannot be suppressed sufficiently. On the other hand, when the thickness of the substrate exceeds 500 μm, the trapped air can be shielded adequately; however, when the sealing material layer hot melt/fluidize, it becomes difficult for the sealing material to effect sealing while the sealing material completely covers the substrate of the pressure-sensitive adhesive tape. For example, when the adherend is a roof ditch, the volume of a gap formed between the side face of the roof ditch and the edge of the pressure-sensitive adhesive tape substrate becomes large, and the sealing material hardly covers the entire side face thereof. As a result, the seal sometimes becomes faulty, or a poor outer appearance with an edge trace of the barrier layer left on the coating surface is sometimes formed.

The sealing material will be explained below.

Sealing Article

In the sealing method of the present invention, a conventional sealing article can be used. A sealing article composed of a hot-melt/fluidizable thermosetting sealing material (sealing composition) can be used. Although the sealing article may contain an additional layer such as a resin film in the interior or on the surface of the sealing material, the additional layer is not always necessary because the substrate of the pressure-sensitive adhesive tape plays the role of a barrier. Moreover, the sealing composition is a composition that can be once melted/fluidized at heat treatment temperatures (usually from 80 to 180° C.), and that can subsequently be cured at the same temperatures. In one embodiment, such a composition contains an epoxy-containing material and a curing agent therefor, and a thermoplastic resin that is melted/fluidized at temperatures up to the curing temperature of the epoxy-containing material. Moreover, in another embodiment, the sealing composition contains an epoxy-containing material and a curing agent therefor, and the epoxy-containing material contains an epoxidized thermoplastic resin that also shows the properties of a thermoplastic resin component.

The sealing composition comprises, for example, a curable epoxy-containing material, a thermoplastic polyamide component having a softening point not higher than the curing temperature of the epoxy-containing material, and a curing agent for the epoxy-containing material. The sealing composition contains in one preferred embodiment of the present invention from 10 to 60% by weight of the epoxy-containing material, and from 30 to 70% by weight of the thermoplastic polyamide component.

The sealing composition comprises an epoxy-containing material, a thermoplastic polyamide component and a curing agent for an epoxy resin, and more preferably consists of these components. The epoxy-containing material contributes to the ultimate strength and heat resistance of the sealing composition. On the other hand, the thermoplastic polyamide component imparts conformability to the shape, and deflection and flexibility, particularly at lower temperature. Moreover, the curing agent makes it possible to cure the sealing composition. It is appropriate that the curing agent be thermally activated, and acts to cure the sealing composition when the sealing composition is exposed to a suitable heat source for a suitable time.

A useful epoxy-containing material is an epoxy resin having at least one oxirane ring that is polymerizable by a ring-opening reaction. Such a material is termed epoxide in a broad sense, and includes a monomeric epoxide and a polymeric epoxide. Such a material may be aliphatic, alicyclic or aromatic. Such a material generally has, on the average, two epoxy groups, appropriately at least two epoxy groups per molecule. Moreover, such a material is particularly called polyepoxide, and includes an epoxy-containing material having an epoxy functionality of slightly smaller than 2.0, for example, 1.8. An average number of epoxy groups per molecule is defined as a value obtained by dividing a number of epoxy groups in the epoxy-containing material by a total number of epoxy molecules. A polymerepoxide includes a linear polymer having epoxy groups at the molecular terminal (e.g., a diglycidyl ether of a polyalkylene glycol), a polymer having a skeletal oxirane unit (e.g., a polybutadiene polyepoxide). The molecular weight of the epoxy-containing material may vary from about 58 to 100,000. Moreover, a mixture of various epoxy-containing materials can also be used.

Examples of the useful epoxy-containing material include cyclohexene oxide groups such as epoxycyclohexanecarboxylate esters that are represented by 3,4-epoxycyclohexylmethyl 3,4-epoxycylohesanecarboxylate and 3,4-epoxy-2-methylcyclohexyl methyl-3,4-epoxy-2-methylcyclohexanecarboxylate, and bis(3,4-epoxy-6-methylcyclohexylmethyl) adipate.

Furthermore, particularly useful epoxy-containing materials include a monomer of diglycidylether such as a glycidylether of a polyhydric phenol obtained by excessively reacting a polyhydric phenol with a chlorohydrin such as epichlorohydrin (e.g., diglycidylether of 2,2-bis-(2,3-epoxypropoxyphenol)propane).

As mentioned below, many epoxy-containing materials are commercially available, and they can be used for carrying out the present invention. That is, they are marketed from Yuka Shell with the following trade names: Epikote 1001; Epikote 1002; Epikote 1003; Epikote 1004; Epikote 828; and Epikote 154. The sealing composition used in the present invention contains a thermoplastic polyamide component. The thermoplastic polyamide component designates a polymer material containing an amide portion of the general formula: 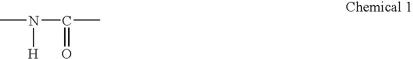
Moreover, such a material is capable of being thermoplastically processed. That is, the material is softened and flows by heating and can be shaped, and the material is then solidified by cooling. Furthermore, the material is softened again by heating. Such a polyamide component realizes not only a desirable mixture with an epoxy-containing material but also a mixture with other component of sealing composition that promotes curing of an epoxy-containing material. Still furthermore, the thermoplastic polyamide component ensures such excellent low temperature characteristics of the sealing composition as flexibility.

A desirable thermoplastic polyamide component is mixed with an epoxy-containing material in a molten phase (namely, melt-mixing) to form a uniform single phase mixture when the epoxy-containing material is not cured. Formation of a uniform single phase becomes evident from the transparency of such a mixture (molten mixture). The sealing composition appropriately contains from 90 to 350 parts by mass of a polyamide component based on 100 parts by mass of the epoxy-containing material. When the sealing composition contains less than about 90 parts by mass of the polyamide component, the cured sealing composition tends to be embrittled. On the other hand, when the sealing composition contains more than about 350 parts by mass of the polyamide component, the cured sealing composition is not sufficiently crosslinked, and tends to flow when heated again. However, curing of the epoxy-containing material results in formation of many phases or isolated phases of the composition. One phase is formed from the cured epoxy-containing material. The other phase results from the thermoplastic polyamide component. However, because the system containing both phases is uniform as a whole, both phases never show nonuniform distribution even when the epoxy-containing material is cured as explained above. As a result, the properties attributed to the epoxy-containing material and those attributed to the thermoplastic polyamide component are imparted to the sealing composition.

Furthermore, a desirable thermoplastic polyamide component has a softening point no higher than the curing temperature of the epoxy-containing material. The sealing composition can then be formed at temperature no higher than the curing temperature thereof. Moreover, the sealing composition can be melted prior to curing. When the sealing composition is employed in the automobile industry, the thermoplastic polyamide component usually has a softening point no higher than about 180° C.

In another embodiment, the sealing composition contains an epoxidized thermoplastic resin and its curing agent. A typical example of the epoxidized thermoplastic resin is an epoxidized ethylene thermoplastic resin. The presence of an ethylene portion makes the resin capable of being hot melted and fluidized, and also makes the resin show low hygroscopicity. Low hygroscopicity of the sealing composition can suppress formation of bubbles caused by moisture evaporation during heating. As a result, the outer appearance of the sealed portion becomes excellent. Ethylene-glycidyl (meth)acrylate copolymer is preferred as the epoxidized ethylene thermoplastic resin. The ethylene-glycidyl(meth)acrylalte copolymer is, as disclosed in Japanese Unexamined Patent Publication (Kokai) Nos. 9-137028 and 10-316955 as one component of an adhesive and a hot-melt composition, an epoxidized polyethylene. This substance is usually obtained by copolymerizing ethylene and glycidyl(meth)acrylate. As a result, the ethylene-glycidyl(meth)acrylate copolymer is formed from an ethylene portion and a glycidyl(meth)acrylate portion. Moreover, the glycidyl(meth)acrylate portion contributes to the adhesion of an electrodeposition coating and finish coating to a steel sheet.

The ethylene-glycidyl(meth)acrylate copolymer is desirably formed from ethylene and glycidyl(meth)acrylate in a weight proportion of ethylene to glycidyl(meth)acrylate of from 50:50 to 99:1 for reasons explained below. The ethylene-glycidyl(meth)acrylate copolymer containing ethylene in a proportion exceeding the above upper limit tends to hardly impart desired mechanical strength and durability to the cured product. Conversely, the ethylene-glycidyl(meth)acrylate copolymer containing ethylene in a proportion lowering the above lower limit tends to become incapable of showing desired low hygroscopicity and sufficient fluidizability.

Furthermore, a typical ethylene-glycidyl(meth)acrylate copolymer is likely to be melted even at relatively low temperature of no higher than about 80° C. When a sealing composition containing the copolymer is heated and fluidized, the composition shows high fluidizability during sealing. The sealing composition consequently shows excellent uniformity and smoothness. Moreover, because the sealing composition can be kneaded at relatively low temperatures in a heating and mixing process, there is practically no possibility that a reaction between a thermosetting component and a curing agent takes place during kneading.

A three component ethylene-glycidyl(meth)acrylate copolymer prepared by copolymerizing or graft polymerizing a third component other than ethylene and glycidyl (meth)acrylate may be used as the epoxidized thermoplastic resin as long as the effect of the present invention is not impaired. Examples of such a three-component copolymer include a copolymer obtained by additionally copolymerizing alkyl(meth)acrylate and a copolymer obtained by additionally copolymerizing vinyl acetate. Moreover, examples of the graft polymer include a polymer obtained by grafting a polystyrene, a polymer obtained by grafting a poly(alkyl(meth)acrylate), and a polymer obtained by grafting an acrylonitrile-styrene copolymer.

Another typical example of the epoxidized thermoplastic resin is an epoxidized styrene thermoplastic resin. The presence of a conjugated diene makes the resin hot-melt/fluidizable and less hygroscopic. The epoxidized styrene thermoplastic resin is a block copolymer having a hard segment composed of a polystyrene and a soft segment composed of an epoxidized polybutadiene and imparting rubber elasticity to the elastomer. Alternatively, an epoxidized polyisoprene can be used in place of or in combination with an epoxidized polybutadiene.

The glass transition temperature (T_{g}) of the epoxidized styrene thermoplastic resin is usually as very low as from −70 to −50° C. The durability (particularly, vibration resistance) of the cured product of the sealing material at temperatures as low as about up to −30° C. can then be increased.

Examples of such an epoxidized styrene thermoplastic resin include a styrene-epoxidized butadiene-styrene copolymer and a styrene-epoxidized isoprene-styrene copolymer. Both copolymers are obtained by epoxidizing the unsaturated bonds of the conjugated dienes.

The epoxidized thermoplastic resins may be used in combination with other epoxy-containing materials. The sealing composition may contain a liquid or solid epoxy resin such as a bisphenol A epoxy resin, a bisphenol F epoxy resin, a novolak epoxy resin or a glycidylamine epoxy resin. Such a substance as mentioned above further improves the heat resistance, durability and adhesion to electrodeposition coated steel sheet of the cured product of the sealing composition. Examples of a desirable epoxy resin include a hydrogenated bisphenol A epoxy resin, an alicyclic epoxy resin, a linear aliphatic epoxy resins such as a butadiene skeletal epoxy resin, and a glycidyl ester epoxy resin such as a dimer acid-modified epoxy resin, which have a relatively low polarity. An epoxy resin having a relatively low polarity is desired because the resin is excellent in compatibility with a less water-absorbing component such as an ethylene portion and a butadiene portion contained in the epoxidized thermoplastic resin. Moreover, the epoxy resin prevents the cured product from absorbing water component, and is advantageous upon heating in the coating step of automobiles. The epoxy resin is used usually in an amount of from 0 to 500 parts by mass, preferably from 5 to 400 parts by mass based on 100 parts by mass of the epoxidized thermoplastic resin.

The sealing composition may further optionally contain a compatibilizer for increasing the compatibility of the epoxidized thermoplastic resin with other epoxy resins. The compatibilizer will be explained in detail. The sealing composition contains usually from 0 to 300 parts by mass of the compatibilizer, preferably from 1 to 100 parts by mass thereof based on 100 parts by mass of the epoxidized thermoplastic resin. Although there is no specific restriction on the compatibilizer as long as compatibilization is effected, the sealing composition appropriately contains a polyester resin or an ethylene-vinyl acetate copolymer (EVA). The compatibilizer is used for the following reason. In particular, when a polyester resin is mixed with an epoxidized thermoplastic resin in a given proportion, the compatibilizer not only prevents separation of the epoxidized thermoplastic resin and epoxy resin but also significantly improves the fluidizability of the sealing composition at curing temperatures from 120 to 180° C.

The sealing composition used in the present invention usually contains from 10 to 90% by weight of an epoxy-containing material. When the sealing composition contains about less than 10% by weight of the material, the heat resistance is lowered. When the sealing composition contains an epoxy-containing material in an amount exceeding about 90% by weight thereof, an amount of a filler that can be added is relatively decreased, and a low linear expansion coefficient cannot be obtained sometimes.

Furthermore, the sealing composition contains a curing agent. The curing agent cures epoxy groups contained in the epoxy-containing material to form a crosslinked structure in the sealing composition and to give a cured product. There is no restriction on the curing agent as long as it can give a cured product. The curing agent may therefore contain, for example, an amine compound such as dicyandiamide, an acrylic compound having a carboxyl group in the molecule (including an acid anhydride) or rosin, an imidazole derivative, a BF₃ complex compound, an organic acid hydrazide, or diaminomaleonitrile or a melamine, or a mixture of these compounds. Moreover, whether the curing agent has a high polarity or low polarity causes no problem. However, as disclosed in Japanese Unexamined Patent Publication (Kokai) Nos. 9-137028 and 10-316955, curing the glycidyl groups of an ethylene-glycidyl(meth)acrylate copolymer requires the use of a curing agent containing an acrylic compound having a carboxyl group in the molecule or rosin. The use of such a curing agent is required because the curing agent is readily compatible with an ethylene-glycidyl(meth)acrylate copolymer and cures the glycidyl groups thereof, as compared with the fact that a curing agent having a high polarity, is not compatible with and substantially unreactive with an ethylene-glycidyl(meth)acrylate copolymer.

The curing agent may be used in combination with a curing accelerator. In particular, a curing accelerator containing a phenol-containing substance, an imidazole derivative or a tertiary amine can be advantageously used for the reaction of a curing agent having a carboxyl group with an epoxy compound.

The sealing composition preferably further contains a filler containing, for example, calcium carbonate, silica or a mixture of the two compounds. The filler can lower the linear expansion coefficient of a cured product. As a result, such a cured product lowers its linear expansion coefficient when the temperature varies particularly at low temperatures, and a shrinkage amount is decreased at low temperatures; the cured product therefore hardly apply a stress to the coating formed by coating the seal material with a paint for automobiles. The coating thus formed hardly forms cracks even at low temperatures.

In general, when a filler is added to the sealing composition as explained above, the sealing composition generally shows no adequate fluidizability during heating and melting. Accordingly, the sealing composition may be made to contain a plasticizer. The sealing composition containing a plasticizer maintains desired fluidizability, because the plasticizer generally has a low viscosity, and contributes to the improvement of the fluidizability of the composition.

Examples of the plasticizer that can be contained in the sealing composition include phthalic acid esters such as di-2-ethylhexyl phthalate or diisononyl phthalate, adipic acid esters, epoxidized aliphatic acid esters, epoxidized soyabean oil, epoxidized linseed oil, liquid terpene resins, liquid terpene-phenol copolymers or liquid terpene-styrene copolymers, azelaic acid esters, sebacic acid esters, epoxyhexaphthalic acid esters or mixtures of these substances. Such a plasticizer can give flexibility to the cured product of the sealing composition. Moreover, the cured product lowers the glass transition temperature so that the cured product has a low elastic modulus even at temperatures as low as from −20 to 40° C. As a result, the cured product can be greatly elongated even at such low temperatures, and can improve the dynamic durability such as vibration resistance.

The sealing method of the present invention comprises affixing a pressure-sensitive adhesive tape having a specific substrate as explained above to a part to be sealed such as a roof ditch, placing a sealing article that contains a hot-melt/fluidizable thermosetting sealing material on the pressure-sensitive adhesive tape, and heating the sealing article to temperature sufficient to the article hot molt/fluidize and thermoset so that the adherend is sealed. Heating in such a sealing method can be conveniently conducted by the heating step in the coating step of automobiles. For example, when electrodeposition coated steel sheets are to be sealed together, the sealing article is applied to the steel sheets prior to precuring that is a pre-drying step of electrodeposition coated steel sheets. The steel sheets are heated at precuring temperature (e.g., from 80 to 160° C.) for a certain time (e.g., from 10 to 20 minutes) to allow the sealing material hot melt/fluidize, and to cure the fluidized sealing material in some cases. The steel sheets are then sprayed with a paint for finish coating, heated to the curing temperatures of the coating (e.g., from 120 to 180° C.) to complete curing of the sealing material. In addition, there are usually two types of finish coatings: a single layer coating obtained by spraying one layer solid paint, and thermosetting the paint; and a two layer coating obtained by spraying a solid paint called an intercoating paint, thermosetting the paint, spraying a solid paint called a topcoat paint, and thermosetting the topcoat paint.

### EXAMPLES

The present invention will be explained below by making reference to examples.

Preparation of a Test Piece (Roof Ditch) Assumed to Have Spot Traces

A test piece, 400 mm (long)×5 mm (deep)×12 mm (wide), simulating a roof ditch of an automobile was prepared. The test piece was prepared by joining (by spot welding) two steel sheets having a thickness of 1 mm bent in a crank-like shape, and electrodeposition coating is applied. Moreover, the shape of the step portion (3 mm wide, 1 mm high) of the ditch is as shown in FIG. 3. Seven recesses each having a depth of 1 mm and a diameter of 6 mm were formed in the roof ditch at intervals of 50 mm along the longitudinal direction using a vice. The recesses are comparable to the worst traces in spot welding in the production line of automobiles.

Pressure-Sensitive Adhesive Tapes

The following pressure-sensitive adhesive tapes were used: (1) Scotch 898 Tape (trade name, manufactured by Sumitomo 3M Ltd.) that is a tape having a total thickness of 155 μm and prepared by forming a natural rubber adhesive layer on a glass fiber-reinforced polyester film 25 μm thick while the glass filaments are impregnated; (2) Scotch 363 Tape (trade name, manufactured by Sumitomo 3M Ltd.) that is a tape having a total thickness of 190 μm and prepared by forming a silicone pressure-sensitive adhesive layer on a substrate having aluminum foil and a glass cloth; and (3) an adhesive tape prepared by coating a 200 μm thick poly(ethylene terephthalate) (PET) film (manufactured by Teijin Ltd.) with an acrylic pressure-sensitive adhesive layer 250 mm thick. Each tape was cut to give a strip-like tape 10 mm (wide)×400 mm (long), and the strip-like tape was used.

Sealing Article (Melt Seal Tape)

Fifty parts by mass of a thermoplastic polyamide (trade name of Macromelt 6238, Henkel), 40 parts by mass of an epoxy substance (trade name of Epikote 1001, manufactured by Yuka Shell Epoxy Co., Ltd.), 7 parts by mass of dicyandiamide (trade name of EH 3636 AS, manufactured by ACR) and 3 parts by mass of a triazine derivative (trade name of 2MZA, manufactured by Shikoku Kasei Corporation) were homogeneously mixed. The mixture was placed in an extrusion molding machine to give a sealing article 4.0 mm thick. The sealing article was cut to give a strip-like tape 10 mm wide and 400 mm long.

### Example 1

Scotch 898 Tape (trade name, manufactured by Sumitomo 3M Ltd.) was affixed to the groove bottom portion of a test piece so that the tape was superimposed on the recesses simulating spot welding traces, and adequately press bonded thereto. The sealing article (melt seal) as described above was affixed to the top surface of the tape.

The coating step of automobiles was taken into consideration. First, a pre-drying step called precuring of electrodeposition coated steel sheets was assumed, and the test piece was allowed to stand at 120° C. (material temperature) for 20 minutes. The above melt seal was melted and fluidized with heat to cover the roof ditch. Next, an acrylic solid paint (crosslinked with melamine) for automobiles generally called an intercoating paint was sprayed on the melt seal, and cured at 140° C. (material temperature) for 30 minutes. An acrylic solid paint (crosslinked with melamine) for automobiles called a topcoat paint was further sprayed, and cured at 140° C. (material temperature) for 30 minutes. The intercoating and topcoat were each from 30 to 40 μm thick after drying. The test piece was allowed to stand for a whole day and night at room temperature, and the outer appearance of the coating on the sealing article was visually observed. The step joint portion of the roof ditch was sectioned with a diamond cutter. The following were then confirmed: the sealing material adequately reached the step portion, and sealing was well effected. In addition, the substrate of the pressure-sensitive adhesive tape showed a tensile elastic modulus of 1,500 MPa during heating the tape at 120° C. (measured at a tensile rate of 50 mm/min, the substrate having a width of 24 mm, a chuck-to-chuck distance of 100 mm).

### Example 2

A test was conducted in the same manner as in Example 1 except that Scotch 363 Tape (trade name, a total thickness of 190 μm, having aluminum foil and a glass cloth as substrate, and a silicone pressure-sensitive adhesive as a coating layer) was used in place of Scotch 898 Tape (trade name, a filament tape). In addition, the substrate of the pressure-sensitive adhesive tape showed a tensile elastic modulus of 350 MPa during heating at 120° C. (measured at a tensile rate of 50 mm/min, the substrate having a width of 24 mm, a chuck-to-chuck distance of 100 mm).

### Example 3

A test was conducted in the same manner as in Example 1 except that a pressure-sensitive adhesive tape prepared by coating a polyethylene terephthalate (PET) film (manufactured by Teijin Ltd.) having a thickness of 200 μm with an acrylic pressure-sensitive adhesive having a thickness of 250 μm in place of Scotch 898 Tape (trade name, filament tape). In addition, the substrate of the pressure-sensitive adhesive tape showed a tensile elastic modulus of 1,000 MPa during heating at 120° C. (measured at a tensile rate of 50 mm/min, the substrate having a width of 24 mm, a chuck-to-chuck distance of 100 mm).

### Comparative Example 1

A test was conducted in the same manner as in Example 1 except that the melt seal tape as it is, was placed on a test piece without using a pressure-sensitive adhesive tape.

### Comparative Example 2

The same sealing composition as produced in Example 1 was extruded by an extrusion molding machine to form a 2 mm thick sheet. Two sheets of sealing material layers were laminated to both sides of a poly(ethylene terephthalate) film, respectively, that was the same as the substrate used in the pressure-sensitive adhesive tape in Example 3 to give a sealing article having a barrier layer in the interior thereof. A test was conducted in the same manner as in Comparative Example 1 using the sealing article. Table 1 shows the test results in Examples 1 to 3 and Comparative Examples 1 to 2.

TABLE 1

| | | | | Comp. | Comp. |
|---|---|---|---|---|---|
| | Ex. 1 | Ex. 2 | Ex. 3 | Ex. 1 | Ex. 2 |
| Outer | 0*¹⁾ | 0*¹⁾ | 0*¹⁾ | X^{*2)} | Δ^{*3)} |
| appearance | | | | | |
| Sealability of | Good | Good | Good | Good | Good |
| step joint | | | | | |
| portion | | | | | |

Note:
*¹⁾ No recess caused by spot welding traces was observed, and the outer appearance of the coating was smooth.
^{*2)} Four recesses caused by bubble shrinkage were observed, and three crater-like traces formed by burst of bubbles on the coating surface were observed.
^{*3)} Four slight recesses formed by bubble shrinkage were observed.

As explained above, according to the sealing method of the present invention, a discontinuous joint is sealed, and at the same time, an outer appearance having significant smoothness without the influence of the shape of the adherend is obtained.

The sealing method of the present invention decreases such defects that may be formed on the coating of automobiles as depressions and recesses, and can impart an excellent coating outer appearance excellent in smoothness and decorativeness.

1. A sealing method comprising:
affixing an adhesive tape to an adherend to be sealed;
placing a sealing article that contains a hot-melt/fluidizable thermosetting sealing material on the adhesive tape; and
heating the sealing article to a temperature sufficient to allow the article to hot-melt/fluidize and thermoset,
wherein the adhesive tape has a substrate that suppresses penetration of air trapped in the affixing step between the adherend and adhesive tape into the sealing article.

2. The sealing method according to claim 1, wherein the substrate is at least one or a combination of a resin film, an unwoven fabric, a woven fabric and a metal.

3. The sealing method according to claim 1, wherein the substrate is a fiber-reinforced resin film.

4. The sealing method according to claim 1, wherein the sealing material contains a curable epoxy-containing material, a thermoplastic polyamide component having a softening point no higher than the curing temperature of the epoxy-containing material, and a curing agent for the epoxy-containing material.

5. The sealing method according to claim 1, wherein the sealing material contains an epoxidized thermoplastic resin and a curing agent thereof.

6. The sealing method according to claim 1, wherein the sealing article is heated at a temperature of from 80 to 180° C.

7. The sealing method according to claim 1, wherein the substrate has a tensile elastic modulus of at least 100 MPa at 120° C.

8. The sealing method according to claim 1, wherein the adhesive tape is a pressure-sensitive adhesive tape.

9. The sealing method according to claim 2, wherein the sealing article is heated at a temperature of from 80 to 180° C.

10. The sealing method according to claim 3, wherein the sealing article is heated at a temperature of from 80 to 180° C.

11. The sealing method according to claim 4, wherein the sealing article is heated at a temperature of from 80 to 180° C.

12. The sealing method according to claim 5, wherein the sealing article is heated at a temperature of from 80 to 180° C.

13. The sealing method according to claim 2, wherein the substrate has a tensile elastic modulus of at least 100 MPa at 120° C.

14. The sealing method according to claim 3, wherein the substrate has a tensile elastic modulus of at least 100 MPa at 120° C.

15. The sealing method according to claim 4, wherein the substrate has a tensile elastic modulus of at least 100 MPa at 120° C.

16. The sealing method according to claim 5, wherein the substrate has a tensile elastic modulus of at least 100 MPa at 120° C.

17. The sealing method according to any claim 2, wherein the adhesive tape is a pressure-sensitive adhesive tape.

18. The sealing method according to any claim 3, wherein the adhesive tape is a pressure-sensitive adhesive tape.

19. The sealing method according to any claim 4, wherein the adhesive tape is a pressure-sensitive adhesive tape.

20. The sealing method according to any claim 5, wherein the adhesive tape is a pressure-sensitive adhesive tape.
